(19) United States
(12) Patent Application Publication
(10) Pub. No.: US 2015/0167947 A1
(43) Pub. Date: Jun. 18, 2015

(54) LOCATION DEVICE

(71) Applicant: Wherible GPS, LLC, Roswell, GA (US)

(72) Inventor: James David Fuqua, JR., Harrisonburg, LA (US)

(21) Appl. No.: 14/565,711

(22) Filed: Dec. 10, 2014

Related U.S. Application Data
(63) Continuation-in-part of application No. 12/878,022, filed on Sep. 8, 2010.
(60) Provisional application No. 61/240,365, filed on Sep. 8, 2009.

(51) Int. Cl. F21V 23/02; F21L 4/08; F21V 33/00; G01S 19/13

(52) U.S. Cl. CPC F21V 23/023; G01S 19/13; F21L 4/08; F21V 33/00

(57) ABSTRACT

A location system for use with a standard flashlight is disclosed. The location system has a GPS receiver and a GPS antenna, as well as a communication element for transmitting the GPS data, and a union to couple the location device to a standard flashlight.

### CONTINUITY DATA

This application claims priority to and the benefit of U.S. patent application Ser. No. 12/878,022, filed on Sep. 08, 2010, entitled “Location Device” which claims priority to U.S. Provisional Application No. 61/240,365 filed on Sep. 8, 2009, entitled “Location Module,” both of which are incorporated herein in their entirety.

### FIELD OF THE INVENTION

The present invention relates generally to GPS device with transmission capabilities, and most particularly to a location based wireless system for use in various electronic devices.

### BACKGROUND OF THE INVENTION

The Global Positioning System (GPS) is a U.S. space-based global navigation satellite system. It provides reliable positioning, navigation, and timing services to worldwide users on a continuous basis. GPS comprises satellites orbiting the Earth, control and monitoring stations on Earth, and the GPS receivers owned by users. GPS satellites broadcast signals from space that are used by GPS receivers to provide three-dimensional location.

Since it became fully operational in 1995, GPS has become a widely used aid to navigation worldwide. It has become a mainstay of transportation systems worldwide, providing navigation for aviation, ground, and maritime operations. Disaster relief and emergency services depend upon GPS for location and timing capabilities in their life-saving missions. Everyday activities such as banking, mobile phone operations, and even the control of power grids, are facilitated by the accurate timing provided by GPS. Farmers, surveyors, geologists and countless others perform their work more efficiently, safely, economically, and accurately using the free and open GPS signals.

Our nation's law enforcement officers and other public servants use GPS in a variety of ways. For instance, most police and fire/rescue vehicles are equipped with GPS tracking modules to enable dispatchers to know the precise location of each vehicle. Additionally, some public servants carry cell phones that are personally trackable, although this option is not always desirable because the cell phone power source is continually drained by the cell phone itself and when it is off or drained, the GPS receiver does not function. Consequently, these technologies are also utilized for monitoring parolees and various types of home incarceration, work permitted individuals throughout the criminal justice system.

Accordingly, it remains desirable to address the limitations of the GPS and cell phone combination and provide public servants and other personnel with a product that is continually powered on and does not comprise the limitations associated with known methods and systems, including but not limited to those limitations discussed above.

### SUMMARY

Presented herein is a location device for use in various electronic devices. In one aspect, the location device comprises a GPS receiver and a GPS antenna. Additionally, in one aspect, the location device comprises a communication element for transmitting the GPS data to a remote receiver. The location device can also comprise a rechargeable power source that can charge simultaneously with the power source of the device within which it resides, or separately, if desired. In one aspect, the location device can further comprise at least one union configured to couple the location device to different electronic devices, such as for example and without limitation, a flashlight.

In yet another aspect, the location device can be part of a tracking system. The tracking system, in one aspect, comprises one or more location devices and a computer aided dispatch system. The computer aided dispatch and device mapping system can be configured to receive the GPS data from the one or more location devices, store the location data, and display the data, including time, location, speed, and the like, on a computer screen or other capable device. It can also have the capability to transmit the location data externally, such as over the internet.

Related methods of operation are also provided. Other apparatuses, methods, systems, features, and advantages of the location device will be or become apparent to one with skill in the art upon examination of the following figures and detailed description. It is intended that all such additional apparatuses, methods, systems, features, and advantages be included within this description, be within the scope of the location device, and be protected by the accompanying claims.

### BRIEF DESCRIPTION OF THE FIGURES

The accompanying drawings, which are incorporated in and constitute a part of this specification, illustrate certain aspects of the instant invention and together with the description, serve to explain, without limitation, the principles of the invention.

FIG. 1 is an exemplified block diagram of one aspect of a location device for installation within a flashlight;

FIG. 2 is a schematic view of exemplified electronic circuits for the location device of FIG. 1, showing circuits for a power supply, a GSM antenna, a GPS antenna, a modem, a GPS receiver, and a SIM card;

FIG. 3 is a partially exploded perspective view of the location device of FIG. 1;

FIG. 4 is a perspective view of an exemplified location device, showing the end cap and a recharging port;

FIG. 5 is a cut away perspective view of the location device of FIG. 4, cut substantially along its longitudinal axis;

FIG. 6 is a cut away perspective view of an end cap for use with the location device of FIG. 4.

FIG. 7 is an exploded perspective view of one aspect of a location device for installation within a flashlight, according to one aspect;

FIG. 8 is an assembled perspective view of the location device of FIG. 7;

FIG. 9 is an exploded elevational view of the location device of FIG. 7; and

FIG. 10 is an assembled perspective view of the location device of FIG. 7.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “enclosure” includes aspects having two or more enclosures unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

Additionally, as used herein, relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

In one aspect, presented herein is a location device 10 for use in various electronic devices 12. For example, and not meant to be limiting, the electronic device can be a flashlight 112. In this example, the electronic device comprises a housing 100 defining an interior cavity 110 and an end cap 500 defining an inner chamber 520. The flashlight has a light assembly 120 comprising a light source 125 positioned at least partially within a portion of the interior cavity. In another aspect, the light assembly can be positioned substantially adjacent a distal end 102 of the housing 100 and the end cap can be selectively coupled to the housing substantially adjacent to a proximal end 104 of the housing 100. Optionally, the location device 10 can comprise a body 510, such as a portion of the end cap 500, so that the location device can be substantially self-contained. That is, the components of the location device can be at least partially positioned within an inner chamber 520 of the body for selective attachment to the various electronic devices.

The location device 10 comprises a location module 200 configured to generate location data for the electronic device. For example, the location module can be positioned at least partially within the interior cavity 100 of the housing, or optionally, at least partially within the inner chamber 520 of the body 510. In one exemplified aspect, the location module 200 comprises a GPS receiver 210 and a GPS antenna 220. In another aspect, the location module further comprises an RF antenna 230. In still another aspect, the location module 200 comprises an accelerometer.

In another aspect, the location device 10 further comprises a communication element 300 positioned at least partially therein the interior cavity 110 of the housing 100, or optionally, at least partially within the inner chamber 520 of the end cap 500, for transmitting the GPS data to a remote receiver (not shown). The communication element 300, for example, can comprise a dual or quad band GSM modem, a CDMA modem, or a short range RF modem for use with WIFI and home based unlicensed 900 mhz spectrum, as well as Bluetooth. One example of a communication element comprises a GSM or CDMA based module that utilizes both GPS and AGPS location (Assisted GPS) services. In one exemplified aspect, the communication element can comprise a Telit CL865 CDMA or GL865 GMS module, as well as location module elements, such as GPS, AGPS, RF, and an accelerometer.

In another aspect, the location device 10 further comprises a Subscriber Identity Module, or SIM card 310. The SIM card 310 can be coupled to the communication element. The SIM card can be, for example and not meant to be limiting, an Infineon™ SLM76 series chip. However, as one skilled in the art can appreciate, other SIM cards are contemplated for use with the communication element.

The communication element 300 can, for example, be coupled to the GPS receiver 210 via a universal asynchronous receiver/transmitter (UART). In this example, the GPS receiver can be coupled to the GPS antenna 220 using a miniature RF connector or SMD antenna. For example, and not meant to be limiting, the RF connector may comprise a miniature BNC, UHF, or IPX connector or SMD antenna. Additionally, the communication element can also be coupled to a GSM PIFA, or other antenna, using a miniature RF connector.

In one exemplified aspect, the location device 10 can further comprise a power source 400. The power source can be, for example, a PCB power supply. In another example, the power source 400 can comprise a non-rechargeable battery, a lithium ion battery, and/or another rechargeable battery. The power source can comprise a port 410 to connect the power source to an external power supply. In one aspect, the port 410 can comprise a standard USB port positioned on an external portion of the housing 100 and/or the end cap 500. In one exemplified aspect, the power source of the location device 10 can charge simultaneously with a power source of the electronic device to which it is coupled, or alternatively, the power source of the location device 10 can charge separately from the power source of the electronic device to which it is coupled. For example, in the case of a flashlight 112, as mentioned above, a first power source of the light assembly 120 of the flashlight can charge simultaneously with a second power source 400 of the location device 10. Optionally however, the second power source of the location device can charge separately than the first power source of the flashlight 112. In another aspect, the first power source of the flashlight can be electrically isolated from the second power source 400 of the location device 10 so that the power source of the location device only powers the location device (and not a portion of the electronic device, such as, for example and without limitation, the light assembly 120.)

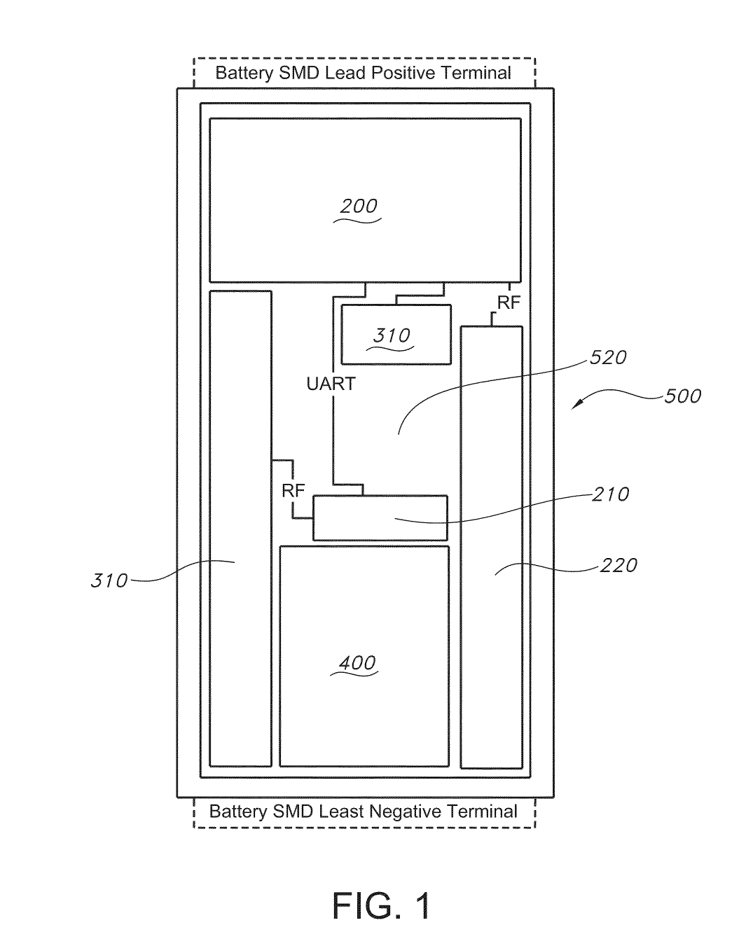

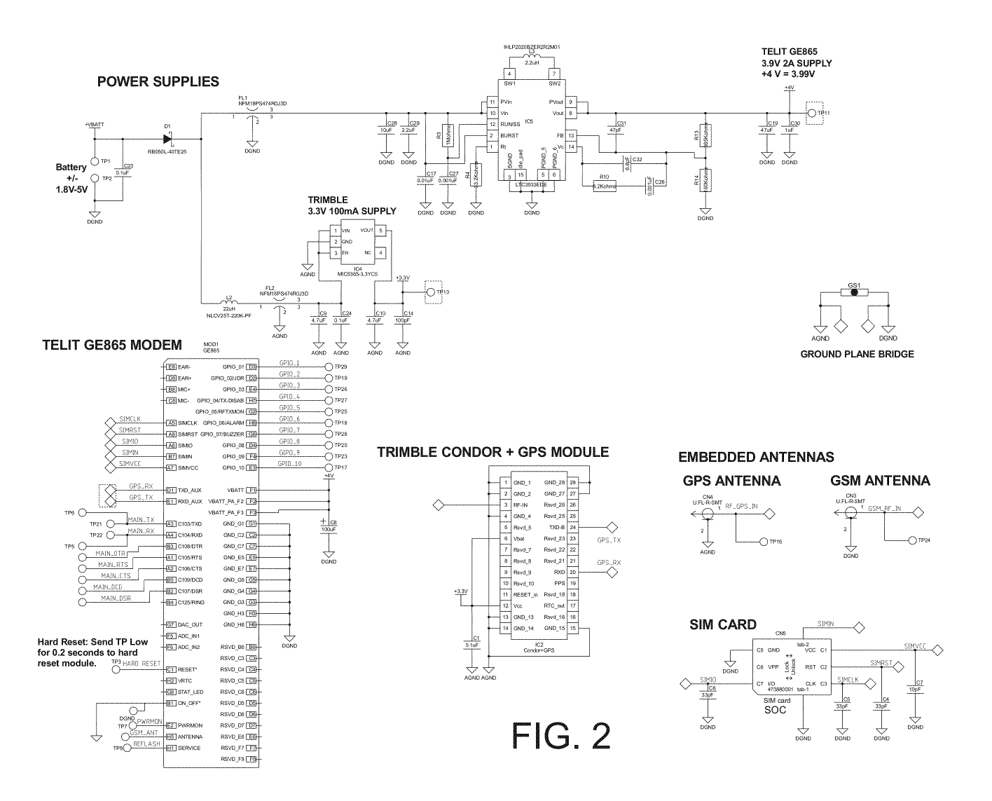

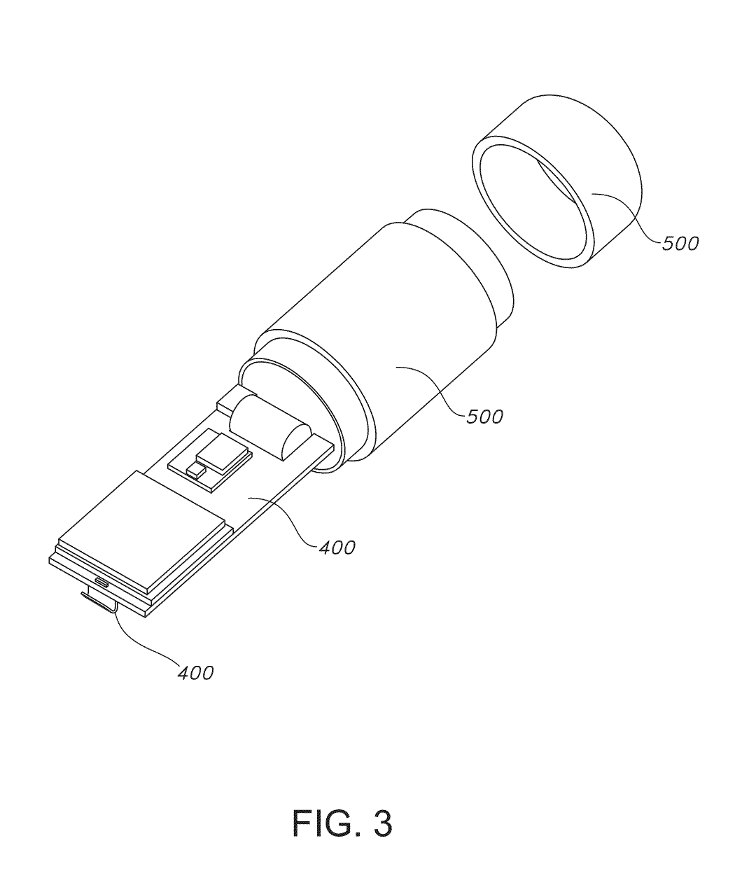

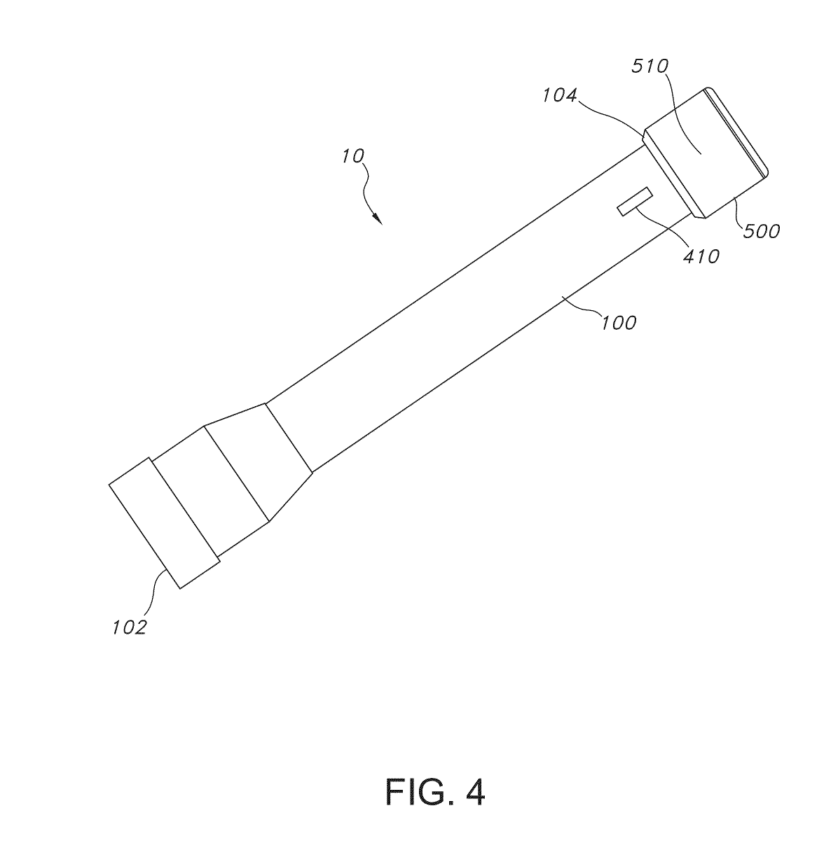

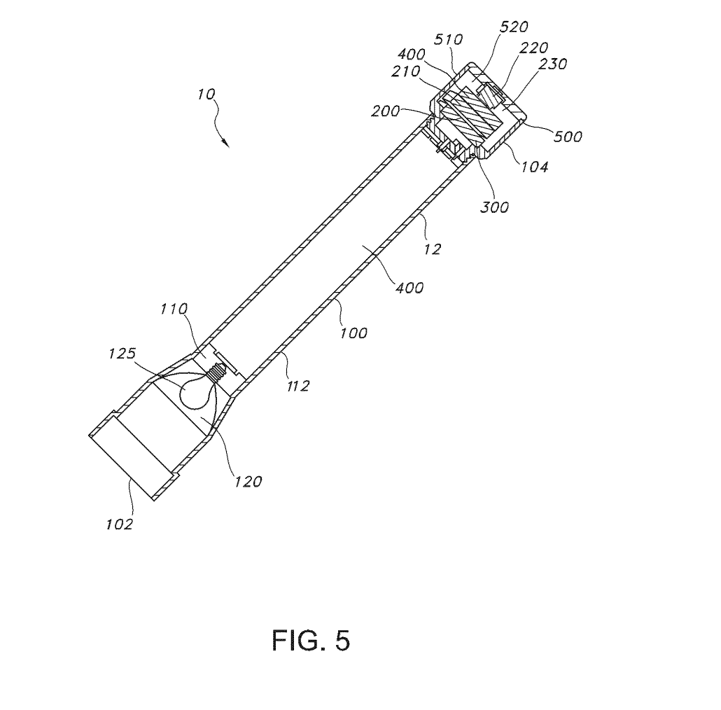

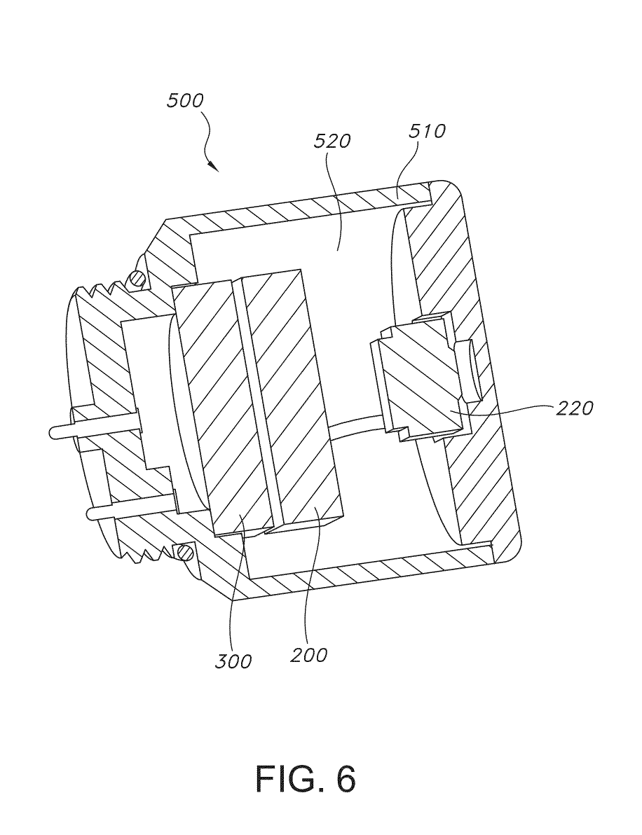

In one aspect, the location device 10 can be configured to take the place of a conventional end cap of an electronic device. For example, the location device can be positioned at least partially within the inner chamber 520 of a modified end cap 500 so that the conventional end cap can be replaced with the modified end cap containing the location device 10 therein. As illustrated in FIG. 1, the location device can be located within the inner chamber 520 of the body 510 of a selectively replaceable end cap. In this aspect, the location device 10 can be coupled to a standard flashlight 112 in lieu of the end cap. In this aspect, the location module 200 and the communication element 300 can be positioned at least partially within the inner chamber 520 of the body 510 of the end cap. As such, a separate power source 400 for the location device 10 can also be positioned therein the inner chamber of the end cap. In use, the modified end cap 500 and the housing 100 can be configured to allow the power source of the flashlight, such as, for example and without limitation, rechargeable batteries, to be charged as per their normal use. Similar location devices can be designed to fit within several other electronic devices, as one skilled in the art can appreciate. In the flashlight 112 example, the housing 100 comprises an aluminum tube matching the design of the flashlight end (or other device, as necessary) with the board cold potted for durability and a laser fused high impact polycarbonate end to house the antenna.

In yet another aspect, the location device 10 can be part of a tracking system. The tracking system, in one aspect, comprises one or more location devices and a computer aided dispatch system. The computer aided dispatch and device mapping system can be configured to receive the GPS data from the one or more location devices 10, store the location data, and display the data, including time, location, speed, and the like, on a computer screen or other capable device. It can also have the capability to transmit the location data externally, such as over the internet.

In another aspect, the location device 10 can be configured to comprise two or more modes of operation. For example, if the location device was used by a police officer, as described herein, modes for patrol and pursuit can be employed and can be triggered automatically or via a signal received from the Computer Aided Dispatch System. In this aspect, the location device 10 can use the standard GPS tracking but also include triangulation to provide Advanced GPS (AGPS). In another aspect, the location module 200 can also provide accelerometer data. The location device can wirelessly transmit to a server the location and status information based on frequency parameters of the “mode”.

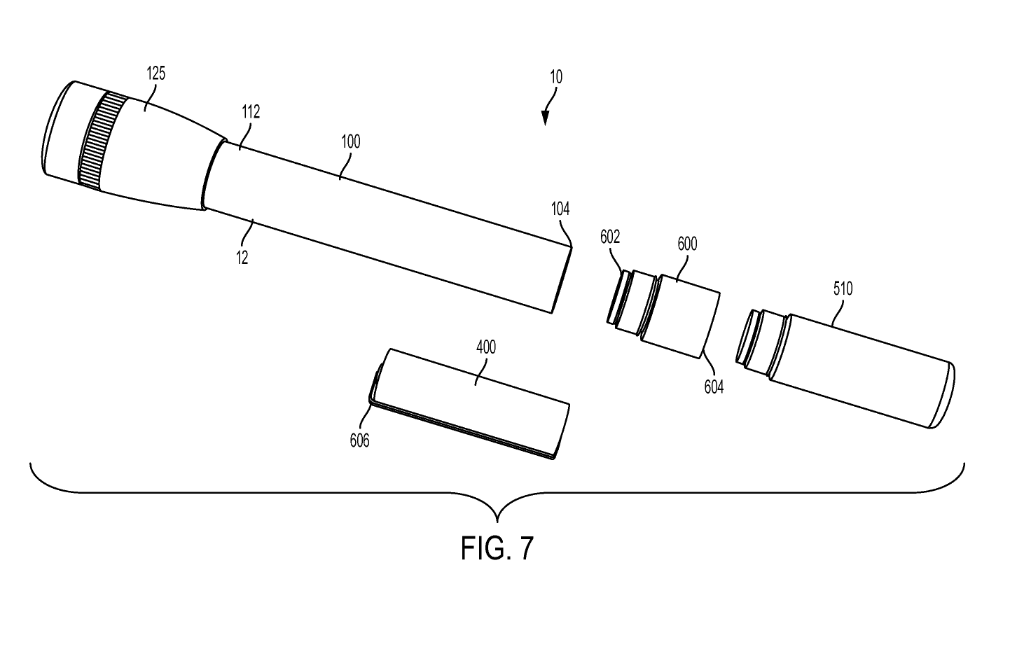

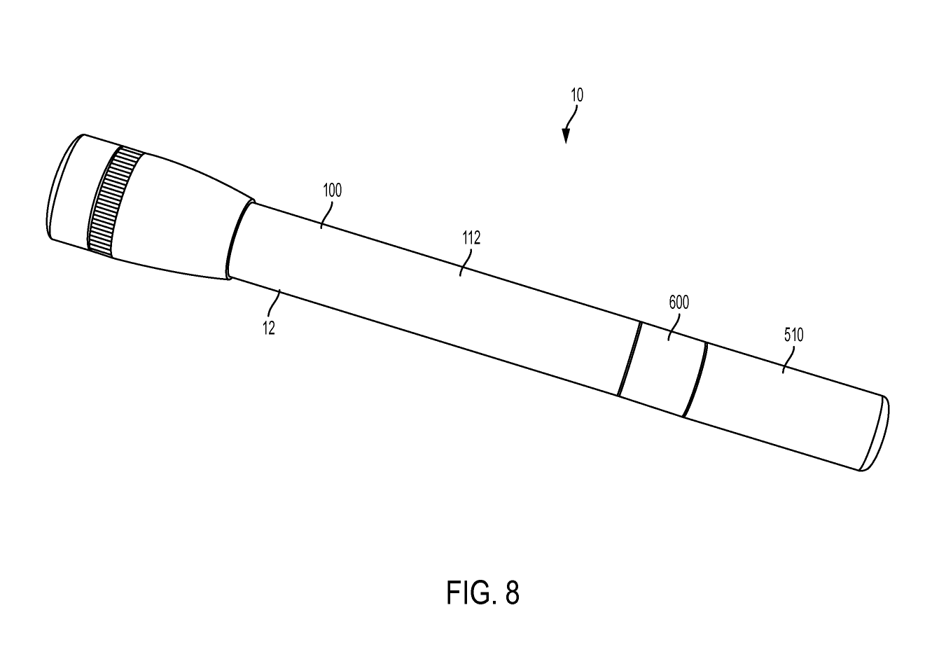

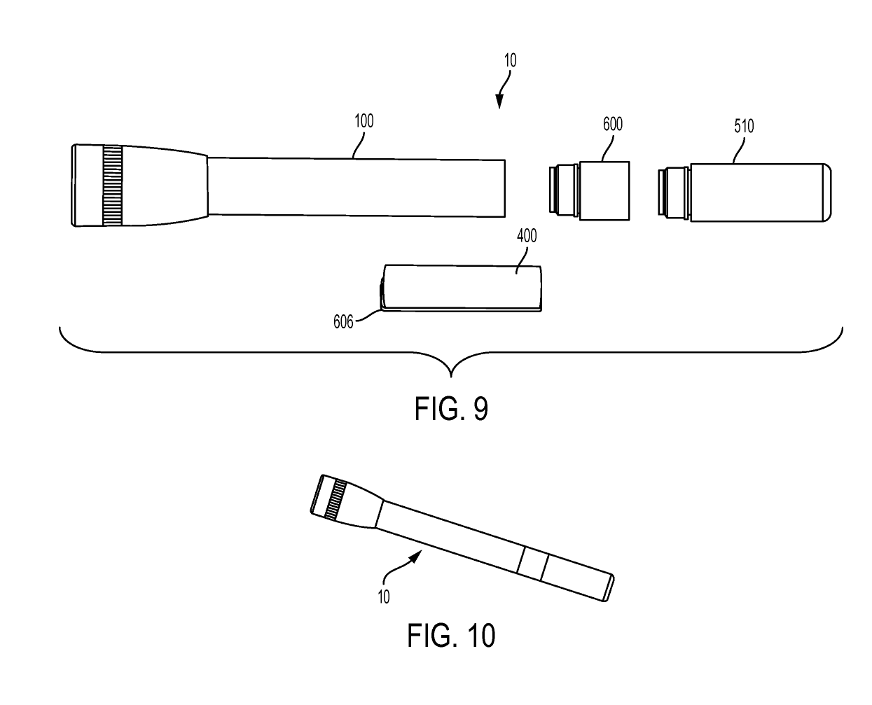

In an exemplified aspect and as illustrated in FIGS. 7-10, the location device 10 further comprises a union 600 configured to couple the location device to a portion of the housing 100. For example, the union can have a first end 602 sized and shaped to matingly engage a portion of the proximal end 104 of the housing, and a second end 604 sized and shaped to matingly engage a portion of the end cap 500 and/or the body 510 of the location device. In one aspect, the location device 10 can comprise a plurality of unions 600, or optionally, at least a choice of several unions, wherein each union is configured to couple the location device to an electronic device having a predetermined size and/or shape. For example, if the electronic device is a flashlight 112, a plurality of unions 600 can be provided so that the location device can be coupled to the housing 100 of the flashlight regardless of the size of the flashlight 112. That is, a first union can be sized and shaped to couple the location device 10 to a first flashlight having a first size, and a second union can be provided to couple the location device to a second flashlight 112 having a second size that is different than the first size. Thus, the body 510 of the location device 10 can be, for example, a standard size and the union can couple the location device with a standard size to flashlights having different sizes. In use then, the union or a plurality of unions can couple the location device 10 to practically any conventional flashlight housing.

In one aspect, the diameter of the first end 602 of the union 600 can be larger, smaller, or substantially similar relative to the second end 604, depending on the size of the housing 100 of the flashlight 112. The union can be equipped to have a complimentary thread pattern relative to the thread pattern on the proximal end 104 of the flashlight housing 100. In another aspect, the first end of the union 600 can be a male connector configured to couple to a female connector formed in the housing. Similarly, the second end of the union can be a female connector configured to couple to a male connector formed in the end cap 500 or body 510. Alternatively, in another aspect, the first end 602 of the union 600 can be a female connector configured to couple to a male connector formed in the housing. Similarly, the second end 604 of the union can be a male connector configured to couple to a female connector formed in the end cap 500 or body 510.

In one aspect, as mentioned herein, the location device 10 can comprise its own power source 400, or it can be electrically connected to the power source of the electronic device. If the location device does not have its own power source, the union 600 can comprise at least one conductor 606 to electrically couple the location device 10 to the power source of the electronic device. For example, the union can comprise a wire configured to engage the power source of the electronic device and couple the power source of the electronic device to the location device 10 so that the power source of the electronic device also provides power to the location device. If the location device has its own power source, the at least one conductor of the union 600 can couple the first power source of the electronic device to the second power source of the location device 10 so that the first and second power sources can selectively be charged at the same time.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A location device for a flashlight having a housing with a proximal end, a distal end, and an outer diameter, a light source positioned at the distal end of the housing, and a first power source positioned within an interior cavity of the housing configured to power at least the light source, the location system comprising:
an end cap defining an inner chamber;
a location module positioned at least partially within a portion of the inner chamber and configured to generate location data;
a communication element positioned at least partially within a portion of the inner chamber and configured to transmit the location data from the location module to a remote receiver, and
a union configured to couple the end cap to the flashlight, the union comprising a first end and a second end, wherein the first end couples to the proximal end of the flashlight, and wherein the second end couples to a portion of the end cap.

2. The location device of claim 1, wherein the first end of the union defines complimentary thread patterns to a thread pattern on the proximal end of the flashlight housing.

3. The location device of claim 2, wherein the second end of the union defines complimentary thread patters to a thread pattern on a portion of the end cap.

4. The location device of claim 1, wherein the union comprises at least one conductor to electrically couple the location device to the first power source of the flashlight, and wherein the first power source powers the location device.

5. The location device of claim 1, further comprising a second power source positioned within the inner chamber and configured to power the location device, wherein the union electrically couples the second power source of the location device to the first power source of the flashlight.

6. The location device of claim 5, wherein the first power source and the second power source are rechargeable power sources, and wherein the first power source and the second power source are charged at the same time.

7. The location device of claim 5, further comprising a USB port positioned on an external portion of the end cap, wherein the USB port is electrically coupled to the second power source.

8. The location device of claim 7, wherein the USB port is electrically coupled to the first power source and the second power source.

9. The location device of claim 1, further comprising a second power source positioned within the inner chamber and configured to power the location device, wherein the first power source and the second power source are not electrically coupled together.

10. The location device of claim 9, wherein the first power source and the second power source are rechargeable power sources, and wherein the first power source and the second power source are charged separately from each other.

11. The location device of claim 1, wherein the location module comprises a GPS receiver and a GPS antenna.

12. The location device of claim 1, wherein the communication element comprises a GSM modem.

13. The location device of claim 1, wherein the communication element comprises a modem.

14. The location device of claim 1, wherein the location module is configured to provide Advanced GPS data.

15. The location device of claim 1, wherein the location module is configured to provide accelerometer data.

16. An end cap for a flashlight having a housing, a light source positioned at a distal end of the housing, and a power source positioned within an interior cavity of the housing for powering the light source, the end cap comprising:
a body defining an inner chamber;
a location module positioned at least partially within a portion of the inner chamber configured to generate location data and a communication element positioned at least partially within a portion of the inner chamber configured to transmit location data from the location module to a remote receiver;
a battery positioned within a portion of the inner chamber and electrically coupled only to the location module and the communication element; and
a union configured to couple the end cap to the housing of the flashlight.

17. The end cap of claim 16, wherein the battery is a rechargeable battery.

18. The end cap of claim 17, wherein the rechargeable battery is charged simultaneously with the power source of the flashlight.

19. The end cap of claim 17, wherein the rechargeable battery is charged separately from the power source of the flashlight.

20. A kit for converting a conventional flashlight into a flashlight having a location device regardless of the size of the flashlight, the kit comprising:
an end cap having a predetermined fixed size and defining an inner chamber;
a location module positioned at least partially within a portion of the inner chamber and configured to generate location data;
a communication element positioned at least partially within a portion of the inner chamber and configured to transmit the location data from the location module to a remote receiver, and
a plurality of unions, wherein each union of the plurality of unions is sized and shaped to couple the end cap to at least one flashlight, wherein each union comprises a first end and a second end, wherein the first end couples to the proximal end of at least one flashlight, and wherein the second end couples to a portion of the end cap.
